(19) United States
(12) Patent Application Publication
(10) Pub. No.: US 2025/0168101 A1
(43) Pub. Date: May 22, 2025

(54) METHOD FOR MODIFYING AN SD-WAN USING METRIC-BASED HEAT MAPS

(71) Applicant: VMware LLC, Palo Alto, CA (US)

(72) Inventors: Navaneeth Krishnan Ramaswamy, Chennai (IN); Arun Kumar Srinivasan, Waterloo (CA)

(21) Appl. No.: 19/034,308

(22) Filed: Jan. 22, 2025

Related U.S. Application Data
(63) Continuation of application No. 18/211,842, filed on Jun. 20, 2023, now Pat. No. 12,237,990.

(30) Foreign Application Priority Data
Jul. 20, 2022 (IN) 202241041528
Jul. 20, 2022 (IN) 202241041529
Jul. 20, 2022 (IN) 202241041530

(51) Int. Cl. H04L 45/02; G06F 9/455; H04L 43/0876; H04L 45/12; H04L 47/24; H04L 67/10

(52) U.S. Cl. CPC H04L 45/02; G06F 9/45558; H04L 43/0876; H04L 45/124; H04L 47/24; H04L 67/10; G06F 2009/4557; G06F 2009/45595

(57) ABSTRACT

Some embodiments provide a method for dynamically deploying a managed forwarding element (MFE) in a software-defined wide-area network (SD-WAN) for a particular geographic region across which multiple SaaS applications is distributed. The method determines, based on flow patterns for multiple flows destined for the multiple SaaS applications distributed across the particular geographic region, that an additional MFE is needed for the particular geographic region. The method configures the additional MFE to deploy at a particular location in the particular geographic region for forwarding the multiple flows to the multiple SaaS applications. The method provides, to a particular set of MFEs that connect a set of branch sites to the SD-WAN, a set of forwarding rules to direct the particular set of MFEs to use the additional MFE for forwarding subsequent data messages belonging to the multiple flows to the multiple SaaS applications.

### CLAIM OF BENEFIT TO PRIOR APPLICATIONS

The present application is a continuation of U.S. patent application Ser. No. 18/211,842, filed Jun. 20, 2023, and published on Jan. 25, 2024, under Publication No. 2024-0031273. U.S. patent application Ser. No. 18/211,842 claims the benefit of Indian Patent Application 202241041528, filed Jul. 20, 2022, Indian Patent Application 202241041529, filed Jul. 20, 2022, and Indian Patent application 202241041530, filed Jul. 20, 2022. These patent applications are incorporated herein by reference in their entireties for all purposes.

### BACKGROUND

Today, cloud-based applications are deployed across hybrid clouds and multiclouds for both availability and resiliency. However, today's SD-WAN network has standard policies that are static in nature for reliable and secure connectivity toward cloud-based applications, which can lead to sub-optimal routing and degraded user experience. Currently, cloud-based transits are provisioned across different regions around the globe in close proximity to cloud-based applications, driven primarily by business values. As a result, considerations for evolving needs of next generation cloud-native applications are lost. Additionally, secure and resilient services are statically provisioned to act as a waypoint for dynamic application clusters, leading to sub-optimal performance and/or application degradation due to the placement of the services, which tend to be located closely to sources rather than destinations.

### BRIEF SUMMARY

Some embodiments of the invention provide a method for generating a heat map and using the generated heat map to modify an SD-WAN (software-defined wide-area network) deployed for a set of geographic locations. The application traffic are handled as flows which are forwarded through a set of managed forwarding elements (MFEs) that generates multiple metrics associated to each of the flows. Based on the collected metrics, the method generates a heat map that accounts for the multiple data message flows, locations of the set of MFEs, and locations of destinations of the data message flows (e.g., SD-WAN applications hosted by public or private datacenters, SaaS (software as a service) applications hosted by third-party datacenters, etc.). The method uses the generated heat map to identify at least one modification to make to the SD-WAN to improve forwarding of the data message flows.

In some embodiments, the method is performed by a management and control server (e.g., Velocloud Orchestrator (VCO)) or cluster of management and control servers for the SD-WAN. The management and control server of some embodiments collects the metrics from the set of MFEs by collecting the metrics from a compute machine designated for collected metrics and location context associated with data message flows in the SD-WAN from the set of MFEs. In some embodiments, the metrics collected by the designated compute machine include quality of experience (QoE) metrics, such as loss rate, packet delay rate, packet jitter rate, and throughput. The designated compute machine, in some embodiments, uses the collected QoE metrics to compute multiple QoE scores associated with the data message flows, and the metrics collected by the management and control server include the QoE scores. In some embodiments, the QoE scores specify traffic densities associated with the data message flows which can be used in conjunction with the heat map to identify modifications to make to the SD-WAN.

The set of MFEs, in some embodiments, include edge routers, cloud gateway routers, and hub routers for connecting datacenters to the SD-WAN. The edge routers of some embodiments are deployed at the edges of datacenters (e.g., branch sites, cloud datacenters, etc.) of an enterprise network for which the SD-WAN is implemented, and connect these datacenters to other forwarding elements (e.g., hub routers and gateway routers) of the SD-WAN. In some embodiments, the gateway routers connect the edge routers to third-party datacenters through the SD-WAN, and, in some embodiments, also perform other operations for the SD-WAN such as route advertisement. The edge routers connect to the cloud gateway routers via two channels, according to some embodiments, with one channel being a secure channel and the other channel being an unsecured channel. The hub routers of some embodiments connect different edge routers to each other. For instance, the hub routers connect edge routers at branch sites to other edge routers at other branch sites and at datacenters that host SD-WAN applications, in some embodiments.

In some embodiments, the heat map groups destinations into various destination clusters based on geographic proximity of the destinations to each other. For instance, multiple SaaS applications may be distributed across a large geographic area (e.g., the United States), with some locations of the geographic area having higher concentrations of SaaS applications than other locations (e.g., higher concentrations near large metropolitan areas). In some embodiments, any modifications to the SD-WAN are identified by first identifying a particular destination cluster at a particular location that does not include a geographically proximate MFE for forwarding data message flows to and from the particular destination cluster, and then provisioning and deploying a new MFE to the particular location to improve forwarding to and from the particular destination cluster.

In another example, some embodiments use the heat map to identify any destination clusters experiencing congestion due to high volumes of traffic to those destination clusters. In some embodiments, the locations of the identified destination clusters may already have one or more local MFEs for forwarding data message flows to and from the destination clusters, and new MFEs may be provisioned and deployed to these locations to increase the amount of resources available for forwarding data message flows to and from those destination clusters. Conversely, or conjunctively, some embodiments may implement other modifications, such as modifying physical links at branch sites and datacenters.

In some embodiments, the heat map is used to identify SD-WAN applications needing improvements. For instance, metrics (e.g., throughput, latency, packet loss, and jitter) associated with a particular SD-WAN application may indicate anomalies detected by MFEs when processing data message flows to and from the particular SD-WAN application. Based on the detected anomaly or anomalies, some embodiments modify a number of edge forwarding elements (e.g., edge routers) that connect datacenters to each other through the SD-WAN, a number of hubs (e.g., hub routers) that connect edge forwarding elements to each other through the SD-WAN, and/or link capacities of a set of links used to connect to the particular SD-WAN application. Examples of SD-WAN applications include VOIP applications, database applications, and applications for running virtual machines (VMs), according to some embodiments.

A visualization of the heat map is presented through a user interface (UI) for viewing and analysis by a user (e.g., network administrator), in some embodiments. The UI is provided in some embodiments by the management and control server, which, in some embodiments, also generates the heat map. In some embodiments, the visualization includes representations of the data message flows, representations of the set of MFEs at their respective locations, and representations of the destination and one or more destination clusters at their respective locations, according to some embodiments.

In some embodiments, the visualization is a map of the geographic area across which the SD-WAN is deployed, and with the representations of the MFEs, destinations, destination clusters, and data message flows overlaying the map. In addition to providing the visualization, the UI of some embodiments also enables the user to identify and select modifications to the SD-WAN for implementation by the components (i.e., management and control server, MFEs, etc.) of the SD-WAN. For example, the user may cause the management and control server to provision and deploy an additional cloud gateway router, and also define forwarding rules associated with the additional MFE for use by, e.g., edge routers of the SD-WAN.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 illustrates an example of a visualization of a simplified heat map for an SD-WAN of a particular entity generated in some embodiments and presented through a UI.

FIG. 2 conceptually illustrates a process of some embodiments for generating a heat map and using the generated heat map to identify and implement modifications.

FIG. 3 illustrates a visualization of the heat map of some embodiments in which a hot application is identified.

FIG. 4 illustrates a visualization of some embodiments in which destination clusters (i.e., groups of geographically proximate applications) have been identified.

FIG. 5 illustrates a visualization of some embodiments in which the hot application is relocated from its initial location within a first destination cluster to a location within a second destination cluster.

FIG. 6 illustrates the visualization of some embodiments after the hot application has been relocated to a location within the second destination cluster.

FIG. 7 conceptually illustrates a process performed in some embodiments for provisioning a new cloud gateway router for use in reaching an application or application cluster.

FIG. 8 illustrates a visualization of some embodiments of the heat map after potential locations for cloud gateway routers have been identified.

FIG. 9 illustrates a visualization of some embodiments in which a particular location for new cloud gateway has been selected for the edge routers to use to reach the hot application at its new location.

FIG. 10 conceptually illustrates a process performed in some embodiments to modify the SD-WAN to improve forwarding for one or more flows determined to be hot flows (e.g., flows destined for hot applications).

FIG. 11 conceptually illustrates a diagram showing a cloud gateway that provides connections for a set of edge routers to a set of applications.

FIG. 12 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for generating a heat map and using the generated heat map to modify an SD-WAN (software-defined wide-area network) deployed for a set of geographic locations. From a set of managed forwarding elements (MFEs) that forward data message flows through the SD-WAN, the method collects multiple metrics associated with the data message flows (e.g., metrics generated by MFEs processing the data messages flows). Based on the collected metrics, the method generates a heat map that accounts for the multiple data message flows, locations of the set of MFEs, and locations of destinations of the data message flows (e.g., SD-WAN applications hosted by public or private datacenters, SaaS (software as a service) applications hosted by third-party datacenters, etc.). The method uses the generated heat map to identify at least one modification to make to the SD-WAN to improve forwarding of the data message flows.

In some embodiments, the method is performed by a management and control server (e.g., Velocloud Orchestrator (VCO)) or cluster of management and control servers for the SD-WAN. The management and control server of some embodiments collects the metrics from the set of MFEs by collecting the metrics from a compute machine designated for collected metrics and location context associated with data message flows in the SD-WAN from the set of MFEs. In some embodiments, the metrics collected by the designated compute machine include quality of experience (QoE) metrics, such as loss rate, packet delay rate, packet jitter rate, and throughput. The designated compute machine, in some embodiments, uses the collected QoE metrics to compute multiple QoE scores associated with the data message flows, and the metrics collected by the management and control server include the QoE scores. In some embodiments, the QoE scores specify traffic densities associated with the data message flows which can be used in conjunction with the heat map to identify modifications to make to the SD-WAN.

The set of MFEs, in some embodiments, include edge routers, cloud gateway routers, and hub routers for connecting datacenters to the SD-WAN. The edge routers of some embodiments are deployed at the edges of datacenters (e.g., branch sites, cloud datacenters, etc.) of an enterprise network for which the SD-WAN is implemented, and connect these datacenters to other forwarding elements (e.g., hub routers and gateway routers) of the SD-WAN. In some embodiments, the gateway routers connect the edge routers to third-party datacenters through the SD-WAN, and, in some embodiments, also perform other operations for the SD-WAN such as router advertisement. The edge routers connect to the cloud gateway routers via two channels, according to some embodiments, with one channel being a secure channel and the other channel being an unsecured channel. The hub routers of some embodiments connect different edge routers to each other. For instance, the hub routers connect edge routers at branch sites to other edge routers at other branch sites and at datacenters that host SD-WAN applications, in some embodiments.

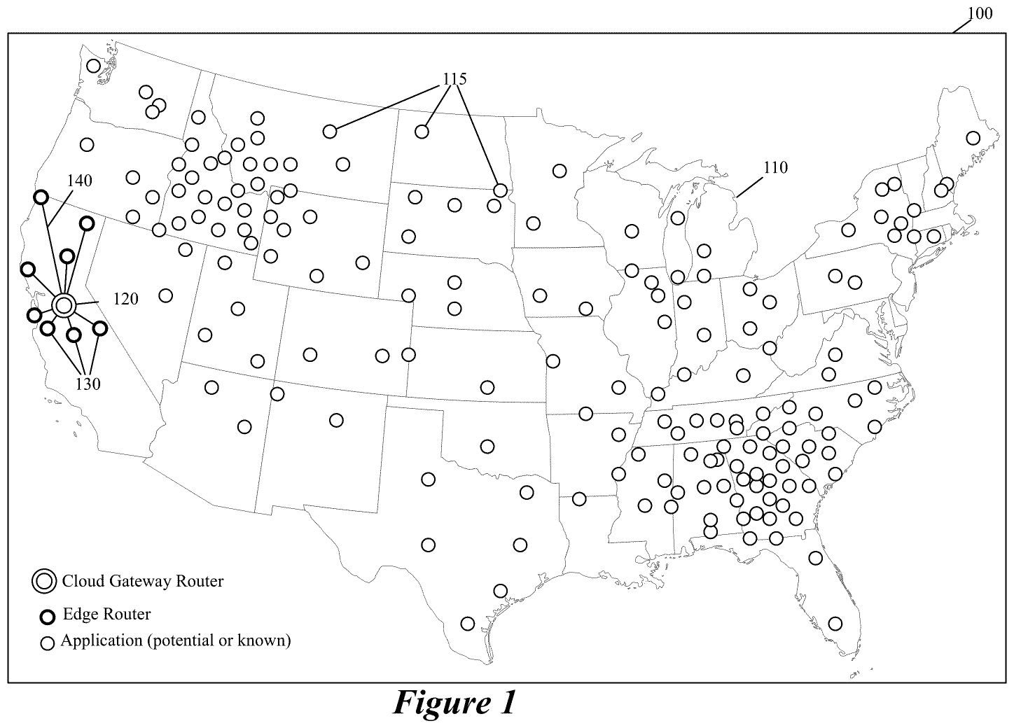

FIG. 1 illustrates an example of a visualization of a simplified heat map for an SD-WAN of a particular entity generated in some embodiments and presented through a UI. The heat map is generated, in some embodiments, by a management and control server for the SD-WAN (e.g., Velocloud Orchestrator (VCO)), and the visualization 100 is presented through a UI also provided by the management and control server. The management and control server, in some embodiments, is a centralized controller, while in other embodiments it is a distributed controller with controller agents executing on devices in the SD-WAN (e.g., on the forwarding elements described below). In still other embodiments, the controller is a cloud gateway that performs the functionalities of a controller, or the controller and the cloud gateway share controller functionalities.

As shown, the visualization 100 includes a map 110 of the geographical area covered by the SD-WAN and being analyzed for potential modifications. Across the map 110, multiple applications 115 are distributed. In some embodiments, each application 115 represents a currently running application (i.e., an application known by the SD-WAN), while in other embodiments, each application 115 represents a potential application, and in still other embodiments, the applications 115 represent a combination of currently running applications and potential applications. It should be noted that while the visualization 100 is illustrated in black and white, other embodiments of the invention present the heat map using a variety of colors to distinguish between the different components of the heat map, as will be further described below. For instance, currently running applications and potential applications may be presented differently (e.g., different colors, different intensity of colors, different opacities, etc.), according to some embodiments.

In addition to the applications 115, the map 110 also includes a cloud gateway 120 (i.e., cloud gateway router) and multiple edge routers 130 connected to the cloud gateway 120 via links 140. The edge routers of some embodiments are edge machines (e.g., virtual machines (VMs), containers, programs executing on computers, etc.) and/or standalone appliances that operate at multi-computer locations of the particular entity (e.g., at an office or datacenter of the entity) to connect the computers at their respective locations to other elements (e.g., gateways, hubs, etc.) in the virtual network. In some embodiments, the elements are clusters of elements at each of the branch sites. In other embodiments, the edge elements are deployed to each of the branch sites as high-availability pairs such that one edge element in the pair is the active element and the other edge element in the pair is the standby element that can take over as the active edge element in case of failover.

An example of an entity for which such a virtual network can be established includes a business entity (e.g., a corporation), a non-profit entity (e.g., a hospital, a research organization, etc.), and an education entity (e.g., a university, a college, etc.), or any other type of entity. Examples of public cloud providers include Amazon Web Services (AWS), Google Cloud Platform (GCP), Microsoft Azure, etc., while examples of entities include a company (e.g., corporation, partnership, etc.), an organization (e.g., a school, a non-profit, a government entity, etc.), etc. In other embodiments, hubs can also be deployed in private cloud datacenters of a virtual WAN provider that hosts hubs to establish SD-WANs for different entities.

Branch sites (e.g., multi-user compute sites), in some embodiments, are locations that have multiple user computes and/or other user-operated devices and serve as source computers and devices for communicating with other computers and devices at other sites (e.g., other branch sites, datacenter sites, etc.). The branch sites, in some embodiments, can also include servers that are not operated by users. In some embodiments, a multi-machine site is a multi-tenant datacenter, such as a Software as a Service (SaaS) provider's datacenter. When the multi-tenant datacenter is a SaaS provider's datacenter, in some embodiments, the forwarding elements that provide access to the multi-tenant datacenter are multi-tenant gateway routers.

The cloud gateway router 120 (also referred to herein as a cloud gateway) in some embodiments is a forwarding element that resides in a private or public datacenter. The links 140 between the cloud gateway 120 and edge routers 130, in some embodiments, are secure connection links (e.g., tunnels). In some embodiments, multiple secure connection links (e.g., multiple secure tunnels that are established over multiple physical links) can be established between one edge router and a cloud gateway.

When multiple such links are defined between an edge router and a cloud gateway, each secure connection link in some embodiments is associated with a different physical network link between the edge router and an external network. For instance, to access external networks, an edge router in some embodiments has one or more commercial broadband Internet links (e.g., a cable modem, a fiber optic link) to access the Internet, an MPLS (multiprotocol label switching) link to access external networks through an MPLS provider's network, a wireless cellular link (e.g., a 5G LTE network), etc. In some embodiments, the different physical links between an edge router 130 and the cloud gateway 120 are the same type of links (e.g., are different MPLS links).

In some embodiments, one edge router 130 can also have multiple direct links (e.g., secure connection links established through multiple physical links) to another edge router, and/or to a datacenter hub router (not shown). Again, the different links in some embodiments can use different types of physical links or the same type of physical links. Also, in some embodiments, different edge routers at different branch sites connect (1) directly through one or more links, (2) through a cloud gateway or datacenter hub router to which one of the edge routers connects through two or more links, or (3) through another edge router of another branch site that can augment its role to that of a hub forwarding element.

The cloud gateway 120 in some embodiments is used to connect two SD-WAN forwarding elements (e.g., an edge router 130 and a forwarding element located in a same datacenter as one of the applications 115) through at least two secure connection links between the gateway 120 and the two forwarding elements at the two SD-WAN sites (e.g., a branch site and a datacenter site (not shown)). In some embodiments, the cloud gateway 120 also provides network data from one multi-machine site to another multi-machine site (e.g., provides the accessible subnets of one site to another site).

In some embodiments, each secure connection link between two SD-WAN forwarding elements (i.e., the cloud gateway 120 and the edge routers 130) is formed as a VPN tunnel (e.g., an overlay tunnel) between the two forwarding elements. Also, in some embodiments, secure connection links are defined between gateways in different public cloud datacenters to allow paths through the virtual network to traverse from one public cloud datacenter to another, while no such links are defined in other embodiments. Also, in some embodiments, the cloud gateway 120 is a multi-tenant gateway that is used to define other virtual networks for other entities (e.g., other companies, organizations, etc.). Some such embodiments use tenant identifiers to create tunnels between a gateway and edge router of a particular entity, and then use tunnel identifiers of the created tunnels to allow the cloud gateway to differentiate packet flows that it receives from edge forwarding elements of one entity from packet flows that it receives along other tunnels of other entities. In other embodiments, cloud gateways are single-tenant and are specifically deployed to be used by just one entity.

The heat map 100 is generated by the management and control server, in some embodiments, based on metrics collected from the various MFEs (e.g., cloud gateway 120 and edge routers 130) of the SD-WAN. In some embodiments, the management and control server receives (or collects) metrics from a compute machine designated for collecting metrics (also referred to herein as a discoverer node (DN)) and location context associated with data message flows in the SD-WAN from MFEs of the SD-WAN. In some embodiments, the metrics collected by the DN include quality of experience (QoE) metrics, such as loss rate, packet delay rate, packet jitter rate, and throughput. The DN, in some embodiments, uses the collected QoE metrics to compute multiple QoE scores associated with the data message flows, and provides these QoE scores to the management and control server. In some embodiments, the QoE scores specify traffic densities associated with the data message flows which can be used in conjunction with the heat map to identify modifications to make to the SD-WAN. In other embodiments, the DN provides additional metrics to the management and control server in conjunction with the QoE scores.

The heat map is used, in some embodiments, to identify issues within the SD-WAN and modifications to make to the SD-WAN to mitigate the identified issues and improve forwarding through the SD-WAN. For example, in some embodiments, the heat map can be used to identify modifications to improve forwarding for points of congestion, for locations having large clusters of destinations (e.g., locations where large amounts of applications are running) without any local MFEs to forward data message flows to the clusters, for specific applications that experience above-average amounts of traffic (e.g., amounts of traffic that exceed a specified traffic threshold), and for specific applications for which certain service requirements (e.g., latency requirements) have been specified. In some embodiments, the management and control server identifies the issues and modifications to mitigate the issues (e.g., based on policies and service rules defined for the SD-WAN by a network administrator) and implements these modifications. In other embodiments, a user (e.g., network administrator) uses the visualization 100 to identify issues in the SD-WAN and define modifications for the SD-WAN through the UI.

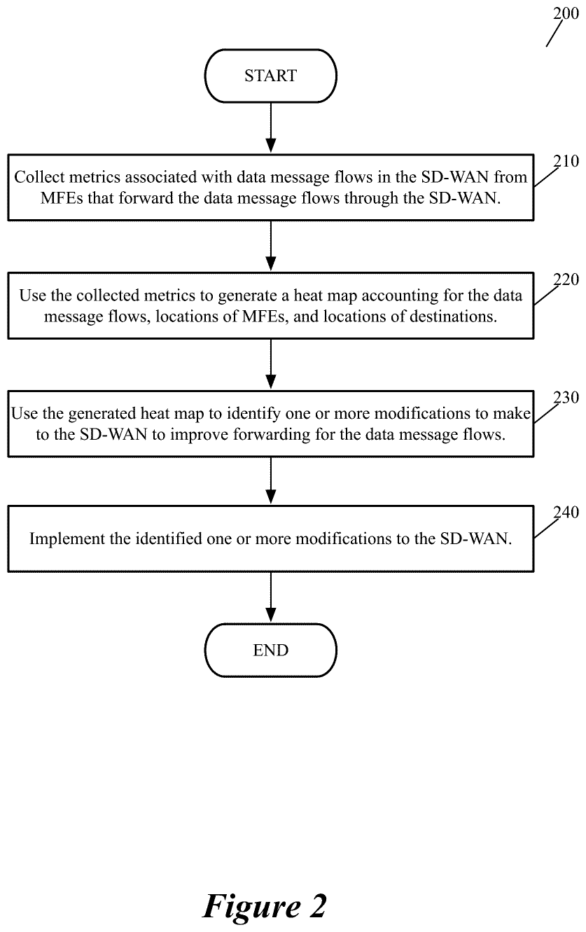

FIG. 2, for example, conceptually illustrates a process 200 of some embodiments for generating a heat map and using the generated heat map to identify and implement modifications. In some embodiments, the process 200 is performed by a management and control server, while in other embodiments, the process 200 is performed by a combination of the management and control server and a user through a UI. The process 200 starts by collecting (at 210) metrics associated with the data message flows in the SD-WAN from MFEs that forward the data message flows through the SD-WAN.

In some embodiments, as mentioned above, the management and control server collects metrics from a DN that is designated for collected metrics from the MFEs of the SD-WAN, such as QoE metrics (e.g., packet loss rate, packet delay rate, packet jitter rate, throughput, etc.). The metrics collected from the DN, in some embodiments, include QoE scores computed by the DN. Alternatively or conjunctively, the collected metrics of some embodiments also include other scores computed by the DN, such as flow density data scores and bandwidth scores.

In some embodiments, the DN only collects metrics from cloud gateways, while in other embodiments, the DN collects metrics from all of the MFEs in the SD-WAN (i.e., cloud gateway routers, edge routers, and hub routers). For example, each cloud gateway in some embodiments is configured to profile a particular set of destinations to discover QoE for applications corresponding to the destinations and arrive at QoE metrics. The cloud gateways in some such embodiments export sets of application QoE metrics, including a list of the destinations (e.g., destination network addresses) to the DN. The management and control server of some embodiments maintains a registry of cloud providers having an appropriate cloud service availability along with associated policies. For example, VMware, Inc.'s VCO maintains a registry of cloud providers having VMware Cloud (VMC) service availability and associated policies.

The DN of some embodiments then begins probing for location context for a given destination list and arrives at a closest cloud provider having the appropriate cloud service available. In some embodiments, the DN uses established services to gather location context for the list of destinations. Examples of established services used in some embodiments include databases that provide contextual data for comprehensive IP address profiles, such as Maxmind and IPinfo.

The process 200 uses (at 220) the collected metrics to generate a heat map accounting for the data message flows, locations of MFEs, and locations of destinations. The visualization 100, for instance, includes representations of applications 115 distributed across the map 110 (i.e., destinations and locations of destinations), as well as representations of cloud gateway router 120 and edge routers 130. In addition to, or instead of, differentiating between known applications and potential applications, the representations of applications 115 in some embodiments may also be presented with varying degrees of intensity (e.g., color intensity) to differentiate between high traffic applications and low traffic applications.

The process 200 uses (at 230) the generated heat map to identify one or more modifications to make to the SD-WAN to improve forwarding for the data message flows. Examples of modifications, in some embodiments, include adding one or more cloud gateway routers or other forwarding elements (e.g., hub routers, edge routers acting as hub routers, etc.) to the SD-WAN, changing which cloud gateways and/or other forwarding elements are used to forward all or groups of certain flows, adding or changing which links are used for all or certain flows, etc.

For example, in some embodiments, a network administrator views a heat map that includes a visualization of a group of flows (e.g., file transfer flows) that are sent from the edge routers 130 and to a particular application located in Illinois via the cloud gateway router 120. Based on the heat map, and QoE metrics associated with the cloud gateway router 120 for the group of flows, the network administrator decides, in some embodiments, that one or more modifications are needed to improve forwarding for the group of flows (e.g., in order to meet a service-level agreement (SLA) associated with the group of flows).

A first potential modification that is identified to improve forwarding for the group of flows, in some embodiments, is to route the group of flows through a different next hop MFE. In some embodiments, the different next-hop MFE is a hub router (not shown) that is more geographically proximate to the particular application in Illinois than the cloud gateway router 120. In other embodiments, such as when there are no geographically proximate hub routers or other MFEs for the particular application, a new MFE (e.g., cloud gateway router) is provisioned near the particular application for forwarding the group of flows to and from the particular application.

In some embodiments, a second potential modification identified for the group of flows is to add hops to the route from the edge routers 130 to the particular application in Illinois to reduce the distance traversed between each hop. For instance, in some embodiments, an existing second MFE (e.g., a hub router (not shown) or second cloud gateway router (not shown)) is identified as a potential next-hop between the cloud gateway router 120 and the particular application to reduce the distance of the last mile connection. Alternatively, or conjunctively, in some embodiments, one or more cloud gateway routers (or other MFEs) are provisioned as additional next-hops between the cloud gateway router 120 and the particular application in Illinois to decrease the distance between each hop.

The identifications are made by the management and control server (e.g., based on policies and service rules defined for the SD-WAN) in some embodiments, and/or by a user (e.g., network administrator) through the UI provided by the management and control server. For instance, a user in some embodiments determines that a particular application or cluster of applications require their own respective cloud gateway for forwarding data message flows to and from the particular application or cluster, and subsequently provisions a cloud gateway to be deployed to a location near the particular application or cluster. In other embodiments, the management and control server determines that the number of hops between a set of source machines and a destination application should be reduced to improve QoE metrics, and generates a new forwarding rule for the flows between the set of source machines and destination application to bypass an intermediate MFE and reduce the number of hops.

The process 200 then implements (at 240) the identified one or more modifications to the SD-WAN. For instance, when a new cloud gateway is provisioned for the SD-WAN, the management and control server of some embodiments provides a set of forwarding rules defined for the new cloud gateway to edge routers of the SD-WAN to direct the edge routers to use the new cloud gateway to forward data messages according to the set of forwarding rules. In some embodiments, the set of forwarding rules may include a list of cloud gateways and, in some embodiments, specify to use the new cloud gateway for flows destined to a particular application, or, e.g., for flows destined to network addresses at a particular location or within a particular region. Following 240, the process 200 ends.

In some embodiments, the management and control server also sends out to the edge routers of the SD-WAN dynamic flow maps that include lists of destinations (e.g., IP addresses, ports, protocols, etc.) along with unique flow-group identifiers (e.g., unique universal identifiers (UUIDs)) and dynamic transit point information for dynamic transit points assigned for different flow-groups. The dynamic transit points, of some embodiments, are cloud gateways that forward data message flows through the SD-WAN. In some embodiments, each cloud gateway that is a dynamic transit point is registered with the management and control server as a dynamic transit gateway.

Each flow group, in some embodiments, is defined based on location-discovery performed by the DN and are identified by flow group identifiers, which are assigned to corresponding dynamic transit identifiers, in some embodiments. Also, in some embodiments, flow groups are defined based on one or more attributes associated with each flow in the flow group. In some embodiments, examples of such attributes include one or more of a destination address or set of destination addresses of the flows, a source address or set of source addresses of the flows, a certain category associated with the flows (e.g., VOIP (voice over IP), video conference, file transfer, etc.), etc.

Different flow groups are defined according to different attributes in some embodiments. For example, in some embodiments, a first flow group is defined based on layer 7 (L7) information, such as an application identifier (appID) that identifies the type of data (e.g., video, VOIP, etc.) contained in the payloads of the packets of the flows in the flow group, while a second flow group is defined based on L7 or contextual attributes (i.e., attributes other than L2-L4 header values) that identify a set of source applications from which the flows emanate (e.g., a particular video conference application or video streaming service application). To obtain such L7 attributes, some embodiments perform deep packet inspection at the edge devices, as further described below. Conjunctively, or alternatively, to using L7 attributes, some embodiments also define flow groups based on other L2-L4 header values and/or other non-L2 to L4 contextual attributes associated with the flows in the flow group.

The dynamic flow maps, in some embodiments, are each defined and formatted according to a five-tuple identifier corresponding to a particular destination, a flow group identifier assigned to a group of flows destined for the particular destination, and an identifier associated with a dynamic transit point through which the particular destination can be reached. The edge devices of some embodiments use software-defined routing to leverage the dynamic flow maps and forward application traffic toward the best available cloud gateway.

Each of the edge routers, in some embodiments, processes the received dynamic flow maps and installs special aggregated routes based on the flow-group UUIDs that are uniquely associated with dynamic transit gateway identifiers as next-hop logical identifiers. As flows are received at the edge devices, each edge device performs a flow-map check, in some embodiments, and identifies a flow group associated with a received flow. For example, in some embodiments, each edge device collects attributes from received packets and uses the collected attributes to perform the flow-map check to identify the associated flow group. As described above, each flow group is defined, in some embodiments, based on one or more attributes, and as such, each edge device of some embodiments collects attributes from each received packet to identify the flow group associated with the packet. In some embodiments, each edge device includes a deep packet inspector for performing deep packet inspection (DPI) on received packets to extract and collect contextual attributes (e.g., L7 attributes) for use in performing the flow-map check.

In some embodiments, once an edge device has identified a flow group corresponding to the received packet, and the UUID associated with the identified flow group, the edge device performs a special aggregated route lookup action to identify a route based on the UUID associated with the identified flow group. The edge device of some embodiments then uses a logical identifier of the dynamic transit gateway corresponding to the flow group UUID to route the received flow (e.g., by sending the traffic on an overlay tunnel associated with the dynamic transit gateway), according to some embodiments.

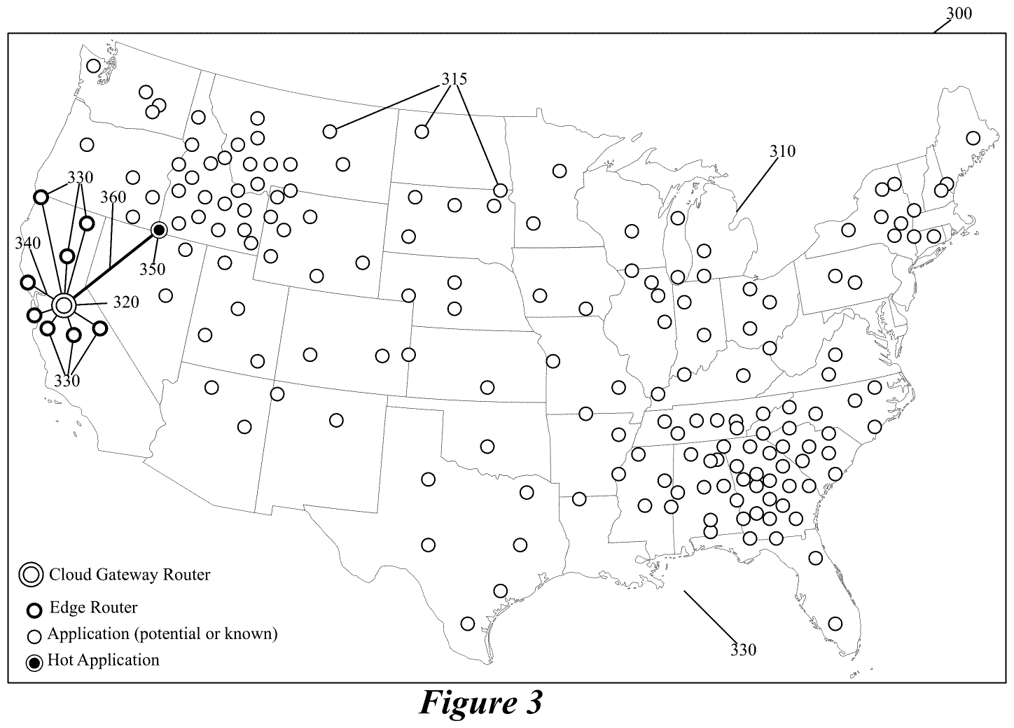

FIGS. 3-9 illustrate additional example visualizations of a heat map for an SD-WAN, in some embodiments. FIG. 3 illustrates a visualization 300 of the heat map in which a hot application 350 is identified. Hot applications, in some embodiments, are applications that receive higher than threshold amounts of traffic. Also, in some embodiments, hot applications can include applications of a particular category (e.g., video conference applications). Moreover, the heat map might display a hot region, which is a region that has a large number of other applications (e.g., a dense application cluster). Like the visualization 100, the visualization 300 includes a map 310 of the geographic area spanned by the SD-WAN, representations of applications 315 distributed across the map 310, a cloud gateway 320, and multiple edge routers 330 connected to the cloud gateway 320 by links 340.

As shown, the cloud gateway 320 connects the edge routers 330 to at least the hot application 350 via one or more links 360. While illustrated as a direct link between the cloud gateway 320 and the hot application 350, the one or more links 360 connect the cloud gateway 320 to, e.g., an edge router for a datacenter hosting a server that runs the hot application 350, according to some embodiments. In this example, the hot application 350 is a SaaS application hosted by a third-party datacenter (not shown) and the links 360 are unmanaged links. In other embodiments, the hot application 350 is an SD-WAN application that runs on a server belonging to the entity for which the SD-WAN is implemented and the links 360 are managed links.

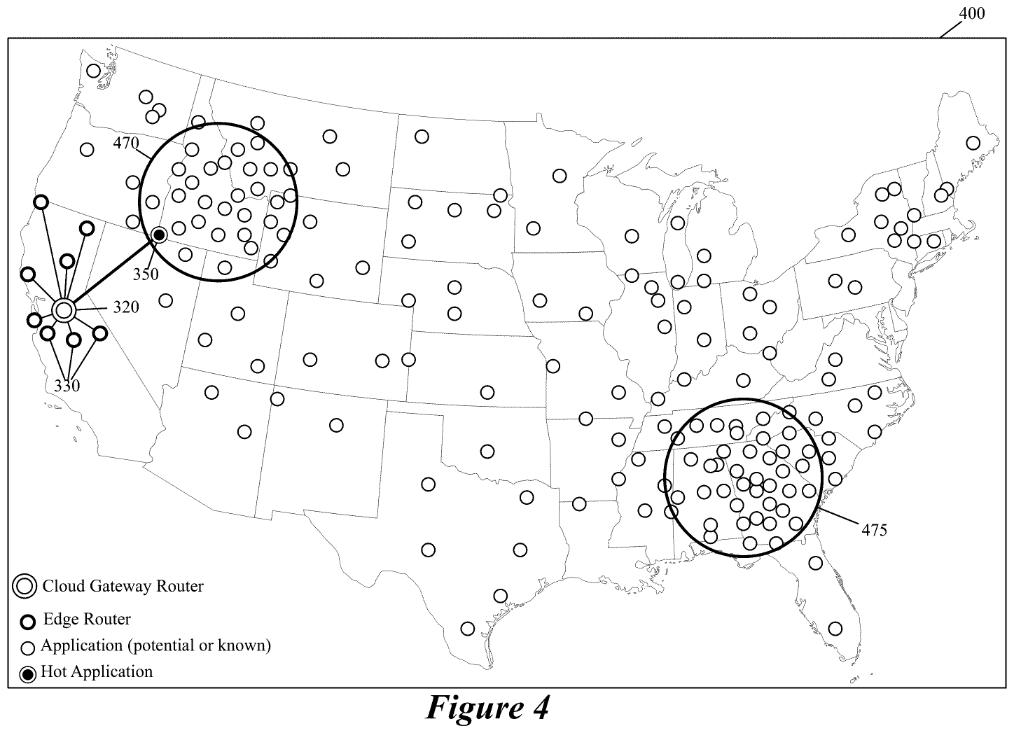

FIG. 4 illustrates a visualization 400 in which destination clusters (i.e., groups of geographically proximate applications) have been identified. The location context (e.g., location context gathered by the DN described above) is used, in some embodiments, to identify larger groups of destinations (e.g., using methods like clustering). As shown, two destination clusters 470 and 475 have been identified, with the hot application 350 located within the destination cluster 470. The center points (centroids) of the destination clusters 470 and 475, in some embodiments, are identified and marked using algorithms, such as Gaussian Mixture Methods (GMM), or using local density estimators, such as DBSCAN. While two clusters are identified in the visualization 400, other embodiments may include additional or fewer destination clusters than illustrated.

In some embodiments, an application may be relocated, while maintaining the same destination network address. The application is relocated, in some embodiments, when a server machine (e.g., a virtual machine (VM) or Pod) on which the application executes is migrated to a new location. In other embodiments, a new server machine is deployed at the new location and configured like the prior server machine on which the application executed. To relocate the application to the server machine at the new location, a new instance of the application is deployed to the new server machine, in some embodiments, and configured in the same way as the previous instance of the application.

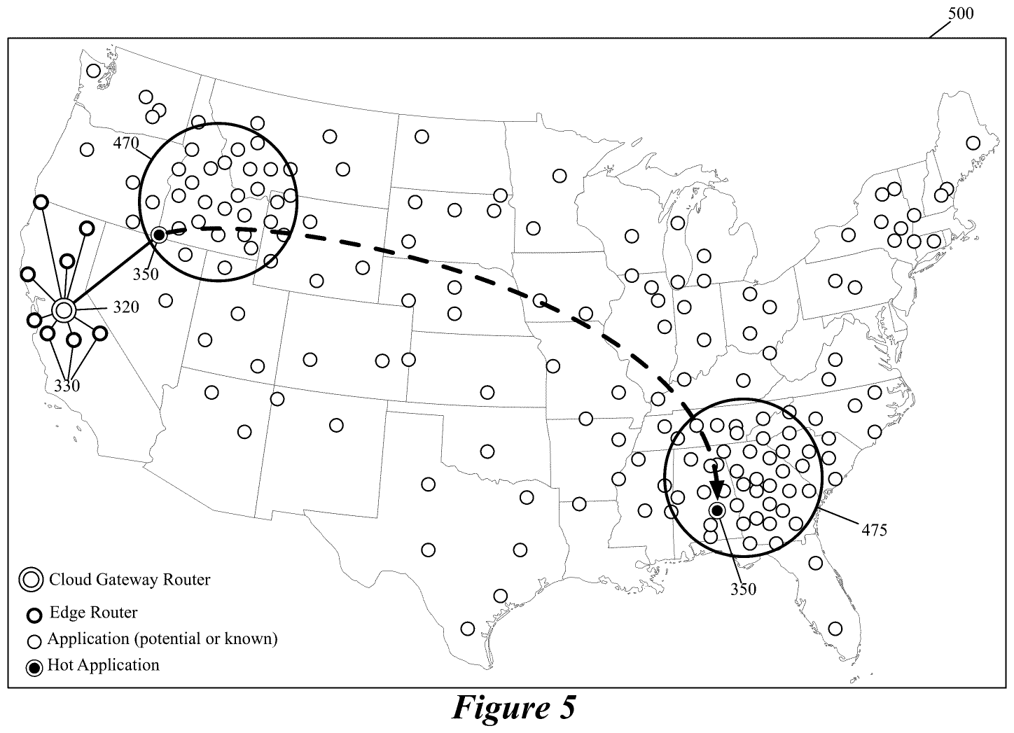

For instance, FIG. 5 illustrates a visualization 500 in which the hot application 350 is relocated from its initial location within the destination cluster 470 to a location within the other destination cluster 475. As shown, the cluster 470 is much more geographically proximate to the cloud gateway 320 than the cluster 475. However, the edge routers 330 are still configured to forward data messages to the hot application 350 using the cloud gateway 320. As a result, data message flows sent between the cloud gateway 320 and the hot application 350 have a longer distance to travel before reaching their destination.

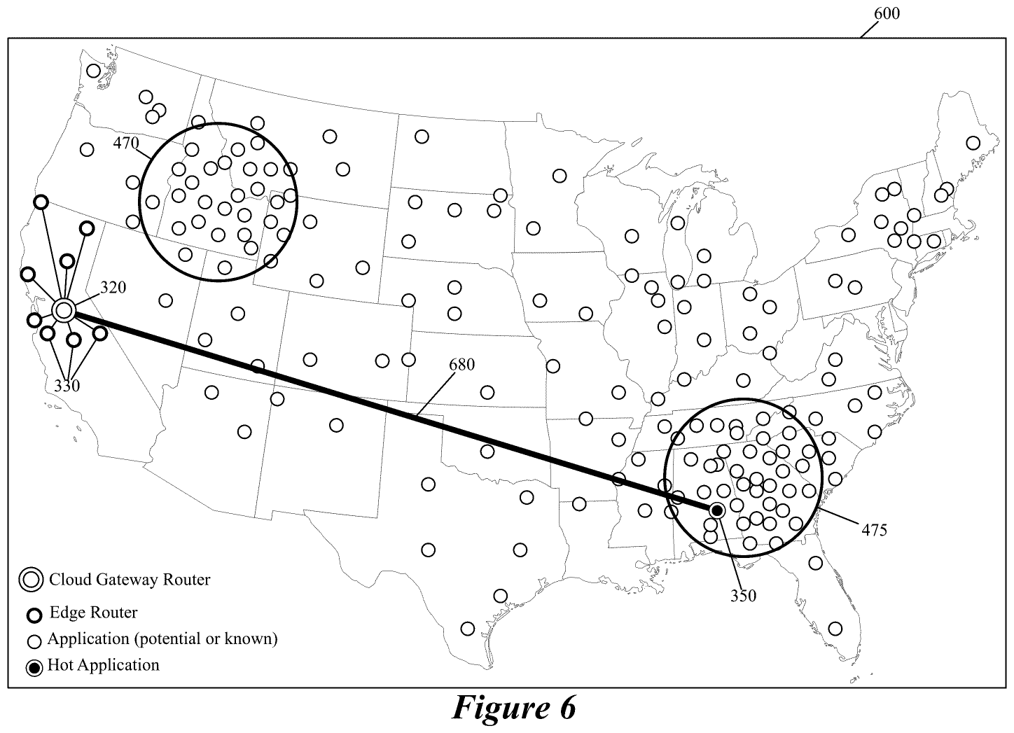

FIG. 6, for example, illustrates the visualization 600 after the hot application 350 has been relocated to a location within the destination cluster 475. The last mile connectivity 680 from the cloud gateway 320 to the hot application 350 at its new location covers a much longer distance than the last mile connectivity (i.e., links 360) before the hot application 350 was relocated. Due to the increased distance, some embodiments experience networking issues that affect QoE for users, such as increased latency. As such, some embodiments use the heat map to identify potential locations for dynamic transit points (e.g., additional cloud gateways) for reaching the hot application 350, and, in some embodiments, for reaching some or all of the other applications located in and around the destination cluster 475.

In some embodiments, additional dynamic transit points are required to reach the hot application 350 based on service requirements associated with the hot application 350. Additional dynamic transit points are also required, in some embodiments, for other applications (e.g., applications that receive less than a threshold amount of traffic), as well as hot applications that have not been relocated. For example, in some embodiments an application is associated with a low latency requirement, and thus a cloud gateway that is geographically proximate to the application is required to ensure that the low latency requirement is met. In some embodiments, using the cloud gateway that is closer to the application may result in a longer round-trip time (RTT) for reaching the application compared to an RTT associated with using a cloud gateway that is farther from the application but closer to the source edge router. In some such embodiments, the longer RTT is preferable due to the lower latency of the last mile connection to the application.

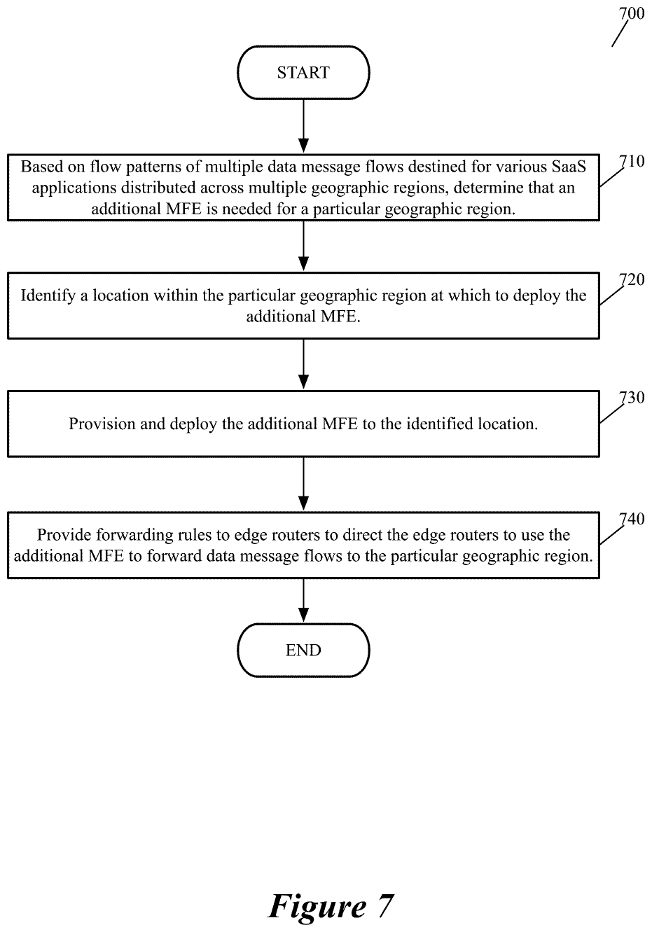

FIG. 7 conceptually illustrates a process 700 performed in some embodiments for provisioning a new cloud gateway router for use in reaching an application or application cluster. The application or application cluster, in some embodiments, can include applications in remote locations, such as the two applications shown within the boundaries of Minnesota in the visualizations of the map 110, as well as the destination cluster 475 before or after the application 350 is relocated. The process 700 is performed in some embodiments by a management and control server for the SD-WAN.

The process 700 starts when, based on flow patterns of multiple data message flows destined for various SaaS applications distributed across multiple geographic regions, the process determines (at 710) that an additional MFE is needed for a particular geographic region. As discussed above, after the hot application 350 is relocated, an additional dynamic transit point (e.g., cloud gateway) is needed to reach the hot application at its new location. In other embodiments, an application or application cluster may require a new cloud gateway based on a determination that there are no cloud gateways near the application or application cluster. In some such embodiments, as also mentioned above, one or more applications may be associated with service requirements that can only be met by provisioning a local cloud gateway for the application or application cluster.

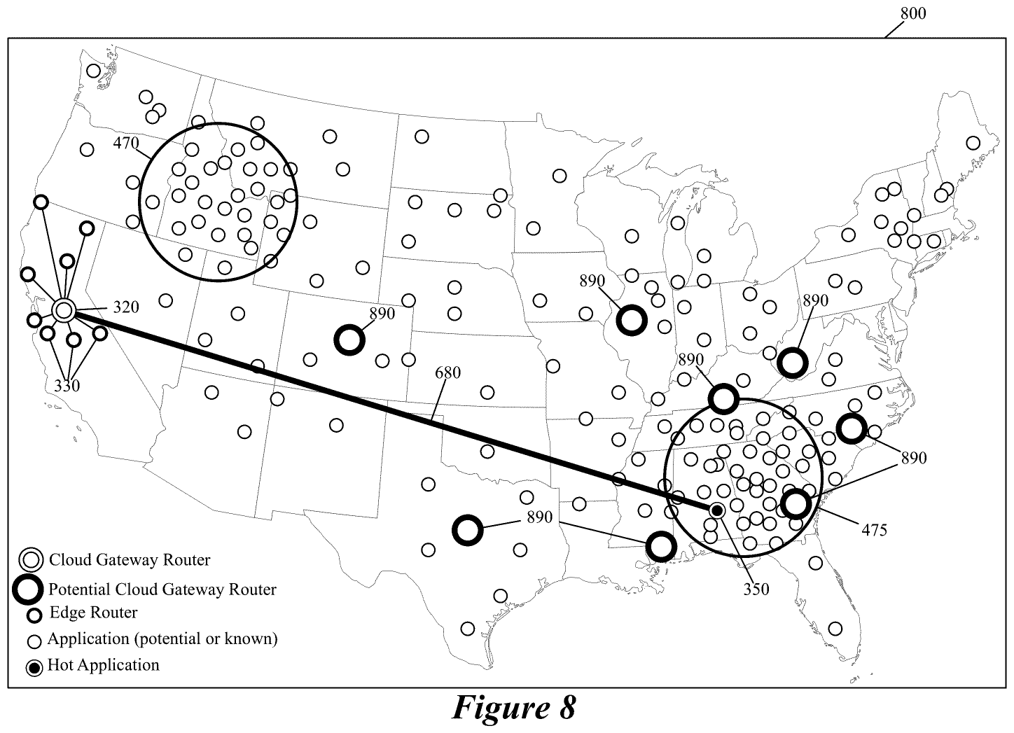

The process 700 identifies (at 720) a location within the particular geographic region at which to deploy the additional MFE. FIG. 8, for instance, illustrates a visualization 800 of the heat map after potential locations for cloud gateway routers have been identified. As shown, eight (8) potential locations for cloud gateway routers 890 (i.e., dynamic transit points) have been identified and presented on the heat map.

In some embodiments, proximity scoping is utilized by the cloud gateway 320 or the management and control server for the SD-WAN to identify the potential locations for dynamic transit points. Tools such as MyTraceroute (MTR) are used, in some embodiments, to trace lossy network segments and find the potential locations. Capacitated P-center algorithms are also employed, in some embodiments, to identify optimal locations for such dynamic transit points. In some embodiments, centroids with lossy network segments are added to the destination clusters 470 and 475. Also, in some embodiments, available edge-compute stacks (i.e., existing MFE instances) that are close to the identified potential locations are added to a set of edge-compute stacks. The management and control server of some embodiments selects a location from the identified potential locations based on QoE scores associated with the locations.

The process 700 then provisions and deploys (at 730) the additional MFE to the identified location. The management and control server of some embodiments registers with a controller service in a cloud provider that is in proximity with SaaS applications in the identified location. In some embodiments, the steps to allocate transit points are as follows. First, identified centroids of application clusters (e.g., destination clusters 470 and 475) are added to a set, Cₖ, where C represents the set of clusters and k represents the number of identified clusters. For Cₖ, a set of transit points, Tₘ, closest to the clusters is selected, where T is the set of transit points and m is the number of selected transit points (i.e., a number of transit points in a set of M transit points). Optimal transit points are then located by applying the capacitated P-center method as mentioned above, and then assigned to edge routers given Eₙ, wherein E is the set of edges and n is the number of edges in a set of N edges, x_{n,m,k} is the estimated utilization (i.e., load) of accessing Cₖ via Tₘ from Eₙ, Lₘ is the maximum load of Tₘ, lₘ is the current load of m, and Qₙ is the maximum number of transit points that can be assigned to an edge router n.

Using the above, the objective is to determine maximum utilization and allocation of transit points, W=ΣnΣmΣk x_{n,m,k}*X_{n,m}+Σm lₘYₘ, where: X_{n,m} is 1 if m is selected for n, or 0 otherwise; and Yₘ is 1 if m is deployed, or 0 otherwise. This objective is subject to a set of caveats. For instance, the total assigned transit points cannot exceed the maximum transit points M, the sum of the estimated total load and current load of a transit point cannot exceed the maximum load of trans point Lₘ, and the number of transit points assigned to an edge n cannot exceed the maximum allowed number of transit points per edge Qₙ. Additionally, the specified integrality constraints include X_{m,n} is equal to 0,1 for any/all m,n; and Yₘ is equal to 0,1 for any/all m.

In some embodiments, the management and control server provisions gateways by triggering a gateway template-based auto-provisioning and activating the gateway instances. The template-based auto-provisioning, in some embodiments, is API-based and provides an automated solution for hosting gateways on target cloud providers (e.g., AWS, GCP, Microsoft Azure, etc.). Once the gateway has been provisioned, the gateway is registered with the management and control server as a dynamic transit gateway, in some embodiments. The management and control server of some embodiments receives metrics (e.g., QoE scores) associated with provisioned dynamic transit gateways and compares these metrics with metrics received before the dynamic transit gateways were provisioned in order to identify improvements. In some embodiments, the management and control server performs auto-scaling out and decommissioning of dynamic transit gateways (e.g., when flow densities fall below established thresholds).

Once the additional MFE has been provisioned and deployed, the process 700 provides (at 740) forwarding rules to edge routers to direct the edge routers to use the additional MFE to forward data message flows to the particular geographic region. In some embodiments, the forwarding rules may specify a particular application or set of applications for which the additional MFE is to be utilized, while all other data message flows to other applications not specified by the rules are to be forwarded using, e.g., a default MFE, even when the other applications are in the same region as the specified particular application or set of applications.

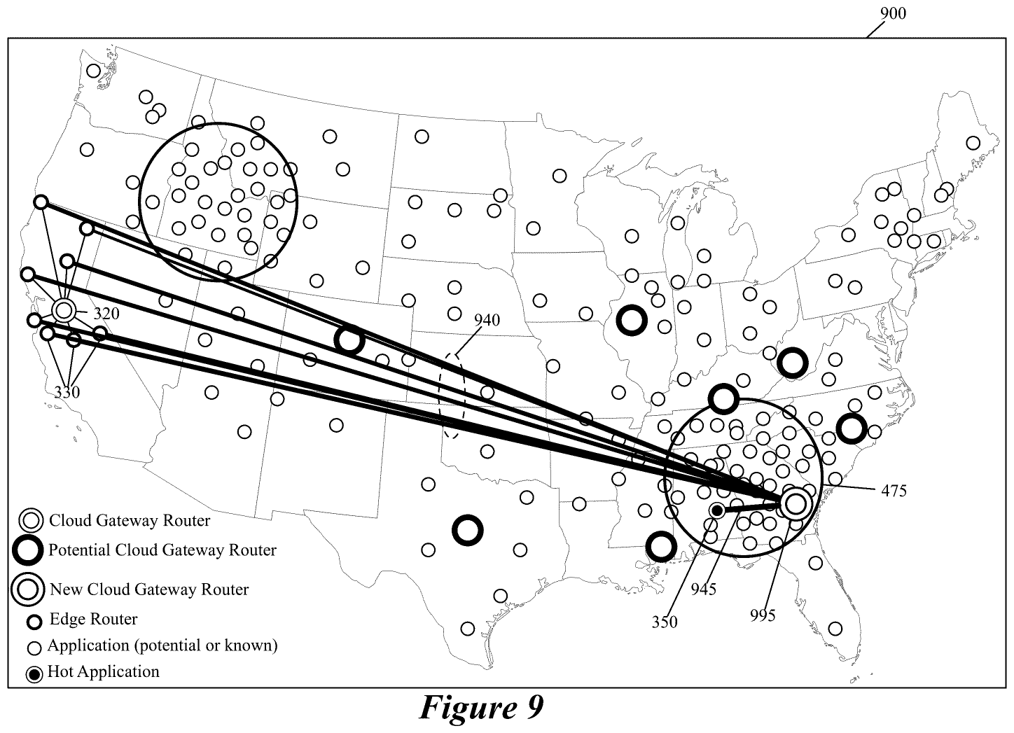

FIG. 9 illustrates a visualization 900 in which a particular location for new cloud gateway 995 has been selected for the edge routers to use to reach the hot application at its new location. As shown, the edge routers 330 have connections 940 to the new cloud gateway 995, which has a significantly shorter last mile connection 945 to the hot application 350. In some embodiments, after deploying the new cloud gateway 995, the management and control server provides forwarding rules to the edge routers to direct the edge routers to use the new cloud gateway 995 for all flows to applications in and around the cluster 475. In other embodiments, the management and control server provides forwarding rules to direct the edge routers to use the new cloud gateway 995 only for flows destined for the hot application 350, and to use the existing cloud gateway 320 for each other flow to the region.

In some of these embodiments, the management and control server also provides new forwarding rules, records, and/or configuration data to the new cloud gateway 995 to direct the new cloud gateway 995 to properly forward flows (e.g., a list of service IP addresses for the service applications, data for setting up tunnels to the computers and/or machines on which the applications execute or to their associated forwarding elements, etc.) received from the edge routers 330 to applications that are running in datacenters in Georgia and one or more neighboring states (e.g., applications in and around the destination cluster 475). Returning to the process 700, following 740, the process ends.

In some embodiments, the DN continues to compute QoE scores from QoE metrics collected from MFEs of the SD-WAN after modifications to the SD-WAN have been made. From the DN, the management and control server collects the computed QoE scores and, in some embodiments, compares these scores against previously collected QoE scores to identify and highlight improvements resulting from the SD-WAN modification(s). In some embodiments, dynamic transit gateways are monitored and, when flow densities drop below established threshold values, in some embodiments, the dynamic transit gateways are auto-scaled and decommissioned.

In several embodiments described above, a new cloud gateway is deployed in a region for reaching a hot application that is relocated to the region (e.g., the cloud gateway 995 that is deployed for reaching the hot application 350 that is relocated from destination cluster 470 to destination cluster 475). In some embodiments, a network administrator can use a heat map to deploy a new cloud gateway even when no applications have relocated, e.g., to deploy the new cloud gateway in a region for applications that currently operate in that region or nearby regions. The following two examples are illustrative of such a use of a heat map.

As a first example, a network administrator of some embodiments views a heat map to identify destination clusters in one region (e.g., destination cluster 475 in the south) being accessed by computing devices in SD-WAN connected sites in another region (e.g., by machines connected to the edge routers 330 in California) through a cloud gateway that is deployed in the other region near the computing devices (e.g., the cloud gateway 320 in California). After noticing this, the network administrator of some embodiments can then decide to deploy a cloud gateway (e.g., a cloud gateway 995 in Georgia) closer to the destination cluster to decrease the distance of the last mile connection to the destination cluster.

Another example involves a network administrator viewing the heat map to identify hot applications located in sparsely, or relatively sparsely, server populated regions (e.g., the two applications located within the bounds of Minnesota on the map 110) that are being frequently accessed by computing devices in SD-WAN connected sites located in other regions (e.g., the machines connected to the edge routers 330 in California) through a cloud gateway located in said other regions (e.g., the cloud gateway 320 in California). After viewing the heat map and identifying such hot applications, the network administrator can decide to deploy a cloud gateway (e.g., a cloud gateway in a public or private cloud datacenter in Minnesota) closer to the identified hot applications so that there is at least one geographically proximate cloud gateway for reaching the hot applications in order to shorten the last mile connectivity to the hot applications.

Additionally, while the embodiments described above provide examples in which a single cloud gateway router is provisioned to improve forwarding, in other embodiments, two or more cloud gateway routers are provisioned to improve forwarding. For example, in some such other embodiments, a first cloud gateway router is provisioned for forwarding flows identified as hot flows, while a second cloud gateway router is provisioned for forwarding all other flows for a particular region. In still other embodiments, one or more additional cloud gateway routers are provisioned to, e.g., decrease the load for an existing cloud gateway router that forwards flows to and from, e.g., a dense destination cluster.

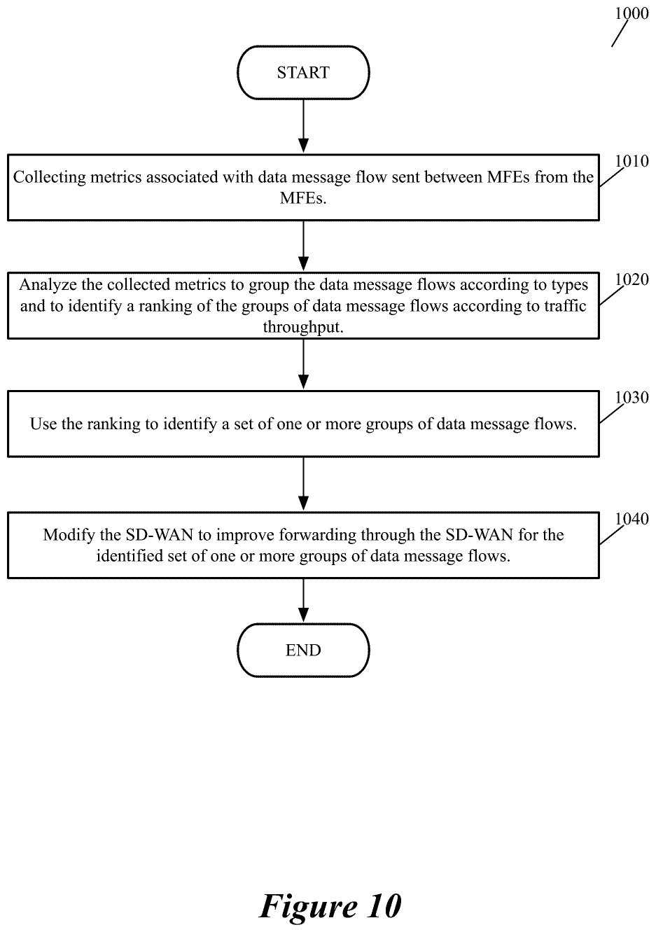

FIG. 10 conceptually illustrates a process 1000 performed in some embodiments to modify the SD-WAN to improve forwarding for one or more flows determined to be hot flows (e.g., flows destined for hot applications). The process 1000 is performed in some embodiments by the management and control server for the SD-WAN. The process 1000 starts when the management and control server collects (at 1010) metrics associated with data message flows sent between MFEs from the MFEs. As discussed above, the management and control server of some embodiments collects QoE metrics from a DN that is designated for collected metrics from the MFEs of the SD-WAN. In some embodiments, each cloud gateway is configured to profile a particular set of destinations to discover QoE for applications corresponding to the destinations and arrive at QoE metrics, which are then collected by (or exported to) the DN.

The process 1000 analyzes (at 1020) the collected metrics to group the data message flows according to types and to identify a ranking of the groups of data message flows according to traffic throughput. In some embodiments, data message flows with high packet rate are defined as hot flows. The hot flows, in some embodiments, also include flows destined for hot applications, and/or include flows from a particular hot source or set of sources that send a lot of packets. In still other embodiments, hot flows include flows belonging to a certain category (e.g., video conference flows, VOIP flows, etc.). In yet other embodiments, hot flows are defined as all, or any combination of, the aforementioned hot flows.

The process 1000 uses (at 1030) the ranking to identify a set of one or more groups of data message flows. For instance, the ranking may group flows based on maximum and minimum thresholds for throughput (i.e., packet rate), and identify the top N groups to include in the set of one or more groups of data message flows. In some embodiments, the identified set of one or more groups will be designated as the hot flows for which modifications to the SD-WAN will be made.

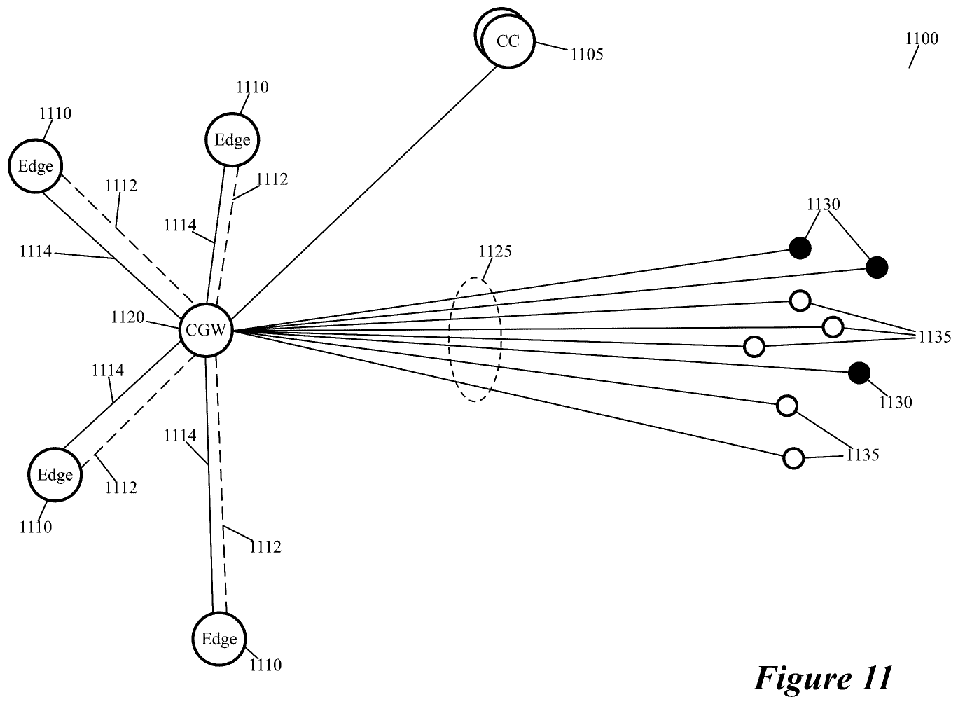

Ranking flows based on their “hotness” will now be described by reference to FIG. 11, which conceptually illustrates a diagram 1100 showing a cloud gateway that provides connections for a set of edge routers to a set of applications. Each of the edge routers 1110 respectively includes two secure connection links 1112 and 1114 to connect to the cloud gateway router 1120. The links 1112 are commercial broadband Internet links (e.g., a cable modem, a fiber optic link), while the links 1114 are optimized MPLS (multiprotocol label switching) links. In some embodiments, each link 1112 and 1114 includes multiple links. The cloud gateway router 1120 connects to the applications 1130 and 1135 via links 1125. The links 1125 are managed links in some embodiments, unmanaged links in other embodiments, and a combination of managed and unmanaged links in still other embodiments.

In this example, the applications 1130 are ranked and defined as hot applications (e.g., applications that receive more than a threshold amount of traffic) while the applications 1135 are applications that experience average amounts of traffic (e.g., applications that receive less than a threshold amount of traffic). As such, the flows that are destined to the hot applications 1130 will be hot flows that will have higher rankings (at 1030) while the flows that are destined to the non-hot applications 1135 will be non-hot flows that will have lower rankings (at 1030).

Returning to the process 1000, the process modifies (at 1040) the SD-WAN to improve forwarding through the SD-WAN for the identified set of one or more groups of data message flows. For instance, in the diagram 1100, in some embodiments, based on metrics collected from the cloud gateway 1120, the controller cluster 1105 provides new or updated forwarding rules to the cloud gateway for distribution to the edge routers 1110 to direct the edge routers 1110 to use the links 1112 when forwarding data message flows associated with the non-hot applications 1135, and to use the links 1114 when forwarding data message flows associated with the hot applications 1130 (i.e., the set of hot flows). In other embodiments, other modifications to the SD-WAN are implemented to improve forwarding for the hot flows, such as adding links (e.g., adding fiber links) between the edge routers and cloud gateway, deploying one or more additional cloud gateways designated for forwarding hot flows, etc. Following 1040, the process 1000 ends.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

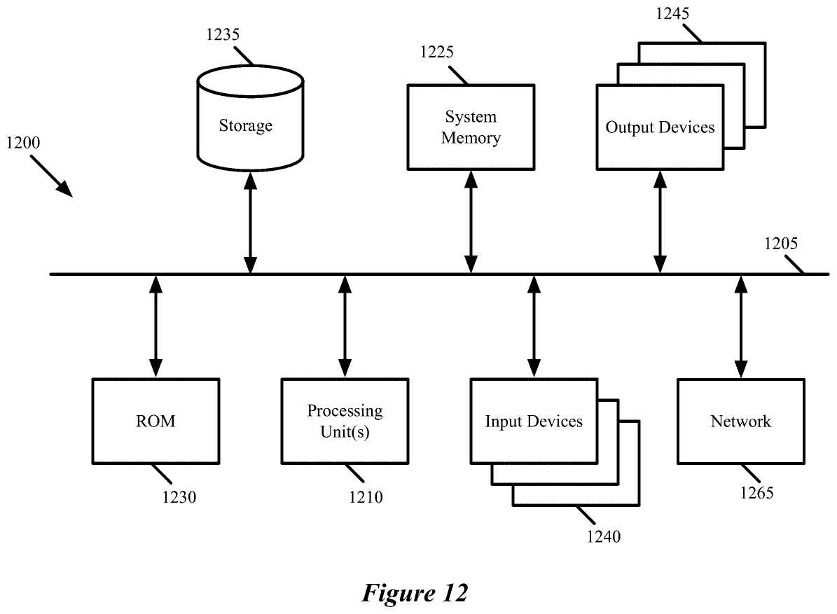

FIG. 12 conceptually illustrates a computer system 1200 with which some embodiments of the invention are implemented. The computer system 1200 can be used to implement any of the above-described hosts, controllers, gateway, and edge forwarding elements. As such, it can be used to execute any of the above described processes. This computer system 1200 includes various types of non-transitory machine-readable media and interfaces for various other types of machine-readable media. Computer system 1200 includes a bus 1205, processing unit(s) 1210, a system memory 1225, a read-only memory 1230, a permanent storage device 1235, input devices 1240, and output devices 1245.

The bus 1205 collectively represents all system, peripheral, and chipset buses that communicatively connect the numerous internal devices of the computer system 1200. For instance, the bus 1205 communicatively connects the processing unit(s) 1210 with the read-only memory 1230, the system memory 1225, and the permanent storage device 1235.

From these various memory units, the processing unit(s) 1210 retrieve instructions to execute and data to process in order to execute the processes of the invention. The processing unit(s) 1210 may be a single processor or a multi-core processor in different embodiments. The read-only-memory (ROM) 1230 stores static data and instructions that are needed by the processing unit(s) 1210 and other modules of the computer system 1200. The permanent storage device 1235, on the other hand, is a read-and-write memory device. This device 1235 is a non-volatile memory unit that stores instructions and data even when the computer system 1200 is off. Some embodiments of the invention use a mass-storage device (such as a magnetic or optical disk and its corresponding disk drive) as the permanent storage device 1235.

Other embodiments use a removable storage device (such as a floppy disk, flash drive, etc.) as the permanent storage device. Like the permanent storage device 1235, the system memory 1225 is a read-and-write memory device. However, unlike storage device 1235, the system memory 1225 is a volatile read-and-write memory, such as random access memory. The system memory 1225 stores some of the instructions and data that the processor needs at runtime. In some embodiments, the invention's processes are stored in the system memory 1225, the permanent storage device 1235, and/or the read-only memory 1230. From these various memory units, the processing unit(s) 1210 retrieve instructions to execute and data to process in order to execute the processes of some embodiments.

The bus 1205 also connects to the input and output devices 1240 and 1245. The input devices 1240 enable the user to communicate information and select commands to the computer system 1200. The input devices 1240 include alphanumeric keyboards and pointing devices (also called “cursor control devices”). The output devices 1245 display images generated by the computer system 1200. The output devices 1245 include printers and display devices, such as cathode ray tubes (CRT) or liquid crystal displays (LCD). Some embodiments include devices such as touchscreens that function as both input and output devices 1240 and 1245.

Finally, as shown in FIG. 12, bus 1205 also couples computer system 1200 to a network 1265 through a network adapter (not shown). In this manner, the computer 1200 can be a part of a network of computers (such as a local area network (“LAN”), a wide area network (“WAN”), or an Intranet), or a network of networks (such as the Internet). Any or all components of computer system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for modifying a software-defined wide-area network (SD-WAN), comprising:
collecting, by a management and control server, metrics associated with data message flows from a set of managed forwarding elements (MFEs) that forward the data message flows through the SD-WAN;
generating, by the management and control server, a heat map based on the collected metrics, the heat map accounting for the data message flows, locations of the set of MFEs, and locations of destinations of the data message flows;
identifying, by the management and control server, at least one modification to make to the SD-WAN based on the generated heat map to improve forwarding of the data message flows; and
implementing, by the management and control server, the at least one identified modification to the SD-WAN.

2. The method of claim 1, wherein collecting the metrics comprises receiving quality of experience (QoE) scores associated with the data message flows from a compute machine designated for collecting QoE metrics from the set of MFEs.

3. The method of claim 2, wherein the QoE metrics comprise at least one of packet loss rate, packet delay rate, packet jitter rate, and throughput.

4. The method of claim 1, wherein generating the heat map comprises:
identifying one or more groups of geographically proximate destinations; and
identifying centroids for each of the one or more identified groups of destinations.

5. The method of claim 1, wherein identifying the at least one modification comprises:
identifying a particular destination cluster at a particular location that does not include a geographically proximate MFE; and
determining to provision and deploy a new MFE to the particular location.

6. The method of claim 5, wherein the new MFE comprises a cloud gateway router.

7. The method of claim 1, wherein implementing the at least one identified modification comprises:
provisioning an additional MFE; and
providing a set of forwarding rules to the set of MFEs to direct the set of MFEs to use the additional MFE for forwarding subsequent data messages belonging to at least a subset of the data message flows.

8. A system for modifying a software-defined wide-area network (SD-WAN), comprising:
a set of managed forwarding elements (MFEs) configured to forward data message flows through the SD-WAN; and
a management and control server coupled to the set of MFEs, the management and control server configured to:
collect metrics associated with the data message flows from the set of MFEs;
generate a heat map based on the collected metrics, the heat map accounting for the data message flows, locations of the set of MFEs, and locations of destinations of the data message flows;
identify at least one modification to make to the SD-WAN based on the generated heat map to improve forwarding of the data message flows; and
implement the at least one identified modification to the SD-WAN.

9. The system of claim 8, wherein the management and control server is configured to collect the metrics by receiving quality of experience (QoE) scores associated with the data message flows from a compute machine designated for collecting QoE metrics from the set of MFEs.

10. The system of claim 9, wherein the QoE metrics comprise at least one of packet loss rate, packet delay rate, packet jitter rate, and throughput.

11. The system of claim 8, wherein the management and control server is configured to generate the heat map by:
identifying one or more groups of geographically proximate destinations; and
identifying centroids for each of the one or more identified groups of destinations.

12. The system of claim 8, wherein the management and control server is configured to identify the at least one modification by:
identifying a particular destination cluster at a particular location that does not include a geographically proximate MFE; and
determining to provision and deploy a new MFE to the particular location.

13. The system of claim 12, wherein the new MFE is a cloud gateway router.

14. The system of claim 8, wherein the management and control server is configured to implement the at least one identified modification by:
provisioning an additional MFE; and
providing a set of forwarding rules to the set of MFEs to direct the set of MFEs to use the additional MFE for forwarding subsequent data messages belonging to at least a subset of the data message flows.

15. A non-transitory computer-readable medium storing instructions that, when executed by a processing unit of a management and control server, cause the processing unit to perform a method for modifying a software-defined wide-area network (SD-WAN), the method comprising:
collecting metrics associated with data message flows from a set of managed forwarding elements (MFEs) that forward the data message flows through the SD-WAN;
generating a heat map based on the collected metrics, the heat map accounting for the data message flows, locations of the set of MFEs, and locations of destinations of the data message flows;
identifying at least one modification to make to the SD-WAN based on the generated heat map to improve forwarding of the data message flows; and
implementing the at least one identified modification to the SD-WAN.

16. The non-transitory computer-readable medium of claim 15, wherein collecting the metrics comprises receiving quality of experience (QoE) scores associated with the data message flows from a compute machine designated for collecting QoE metrics from the set of MFEs.

17. The non-transitory computer-readable medium of claim 16, wherein the QoE metrics comprise at least one of packet loss rate, packet delay rate, packet jitter rate, and throughput.

18. The non-transitory computer-readable medium of claim 15, wherein generating the heat map comprises:
identifying one or more groups of geographically proximate destinations; and
identifying centroids for each of the one or more identified groups of destinations.

19. The non-transitory computer-readable medium of claim 15, wherein identifying the at least one modification comprises:
identifying a particular destination cluster at a particular location that does not include a geographically proximate MFE; and
determining to provision and deploy a new MFE to the particular location.

20. The non-transitory computer-readable medium of claim 19, wherein implementing the at least one identified modification comprises:
provisioning the new MFE; and
providing a set of forwarding rules to the set of MFEs to direct the set of MFEs to use the new MFE for forwarding subsequent data messages belonging to at least a subset of the data message flows.
